(19) United States
(12) Patent Application Publication
(10) Pub. No.: US 2012/0171544 A1
(43) Pub. Date: Jul. 5, 2012

(54) GALVANIC CELL, CELL STACK, AND HEAT SINK

(75) Inventors: Andreas Gutsch, Luedinghausen (DE); Claus-Rupert Hohenthanner, Hanau (DE); Torsten Schmidt, Landsberg (DE); Tim Schaefer, Niedersachswerfen (DE)

(73) Assignee: LI-TEC BATTERY GMBH, Kamenz (DE)

(21) Appl. No.: 13/263,115

(22) PCT Filed: Mar. 30, 2010
(86) PCT No.: PCT/EP10/02029

§ 371 Date: Mar. 21, 2012

(30) Foreign Application Priority Data
Apr. 8, 2009 (DE) 10 2009 016 868.0

(51) Int. Cl. H01M 10/50; H01M 6/50

(52) U.S. Cl. 429/120

(57) ABSTRACT

The invention relates to a galvanic cell (101, 401) having arresters (407, 408) and heat sinks (103, 104, 105, 106, 403, 404, 405, 406) attached thereto. Said heat sinks are designed such that the arrester can be used simultaneously for transporting electrical energy into the cell or out of the cell, and also for removing heat from the cell. The heat sink for cooling galvanic cells is designed such that same can be attached to an arrester of a galvanic cell by force closure, form closure, or adhesive force closure such that the arrester can be used simultaneously for transporting electrical energy into the cell or out of the cell, and also for removing heat from the cell.

The present invention relates to a galvanic cell, to a cell stack and to a cooling element for cooling galvanic cells.

Galvanic cells store energy in chemical form and can take up and give off this energy in electric form. Chemical reactions, which are associated with heat build-up that is frequently significant, take place both during charging and discharging of the cell. The resulting heat must be effectively dissipated so as to prevent the cell from overheating.

It is the object of the present invention to provide a technical teaching for cooling galvanic cells. This object is achieved by a product according to any one of the independent claims.

According to the invention, at least one conductor of a galvanic cell is equipped with a cooling element, which is designed such that the conductor can be used both for transporting electric energy into the cell or out of the cell and for removing heat from the cell.

Advantageous refinements of the invention form the subject matter of dependent claims.

Hereafter, the significance of terms that are used to describe the present invention is explained in more detail in connection with the description of the present invention.

The term galvanic cells as defined by the present invention comprises electric energy stores of all kinds, in particular electrochemical energy stores, which is to say in particular primary cells and secondary cells, but also other electric energy stores, such as capacitors, for example.

The term conductor as defined by the present invention comprises any kind of device in connection with the transport of electric energy into a galvanic cell, or out of a galvanic cell, in particular sheet metal electrodes, or similar devices. In connection with what are referred to as “pouch” or “coffee bag” cells, conductors are preferably sheet metal electrodes, which are connected to the electrode stack of the cell and project from the generally foil-type packaging of the cell, so that the conductors can establish electric contact with contact elements or terminals of an application assembly.

A cooling element as defined by the present invention is any type of device that is suited to facilitate or promote the heat transport from a heat source, which is in contact with the cooling element, to a heat sink. Cooling elements are preferably easily thermally conductive, frequently metallic bodies, which are designed so that they can have intensive thermally conductive contact with the heat source and also so that the effective surface involved in the heat exchange with a heat sink, this surface being referred to as the heat transfer area, is as large as possible. Thus, they are preferably used to enlarge the effective heat transfer area of the heat source, which for various design reasons frequently has only a small heat transfer area without the cooling element.

A connection in the context of the present invention shall be understood as a mechanical, electric and/or thermally conductive connection of two bodies.

A non-positive connection in the context of the present invention shall be understood as a connection of two bodies that is brought about, or at least supported or improved, by the action of one or more forces. Examples of such non-positive connections include screw connections, clamping connections or similar connections in which the bodies involved exert a force on one another, with the force establishing, supporting or improving the quality of the connection.

A positive connection in the context of the present invention shall be understood as a connection of two bodies that is brought about, or improved, due to the design of the two bodies involves. To this end, the shapes of the bodies involved are preferably matched to one another so that, in the case of a thermally conductive connection, the heat transfer area, and in the case of an electrically conductive connection, the electric conductivity, between the bodies that are connected is as large as possible.

A bonded connection in the context of the present invention shall be understood as a connection of two bodies that is provided or enabled by a material. This includes preferably thermally conductive potting compounds, adhesives, pastes or elastic thermally conductive films, which are provided or disposed in gaps between the bodies to be connected so that the connection, which is to say the heat transfer or the current transfer between the bodies involved, is promoted or improved. Bonded connections can also be positive and/or non-positive connections at the same time. Any combination is thus possible.

A stack of galvanic cells in the context of the present invention shall be understood as any arrangement in which a plurality of preferably identical cells is arranged to form a cell stack or an array of cells using an electric series connection and/or parallel connection. Such cell stacks are also referred to as cell blocks or batteries.

A contact element in the context of the present invention shall be understood as an electrically conductive design element, which during the assembly of cells to form a stack, or during the installation of a cell or a cell stack in an arrangement, is used to contact the cells among each other, or to contact a cell or the cell stack with a current source or a current load.

Accordingly, an insulating element in the present invention shall be understood as a design element that, given the insulating properties thereof, is used accordingly to create a cell stack, or to connect cells to a current source or a current load, or to install cells or a cell stack in an arrangement. Insulating elements are preferably used to electrically interconnect the conductors of the cells among one another or to contact elements of the arrangement as intended, in particular to prevent electric connections that are not intended, such as electric short-circuits, for example.

Similarly, a retaining element shall be understood as a design element that is at least partially insulating or electrically conductive, which in addition to the electric insulation or the electric contacting is also used for mechanically fixing cells or cell stacks inside an arrangement.

The invention will be described in more detail hereafter based on preferred exemplary embodiments based on figures.

Shown are:

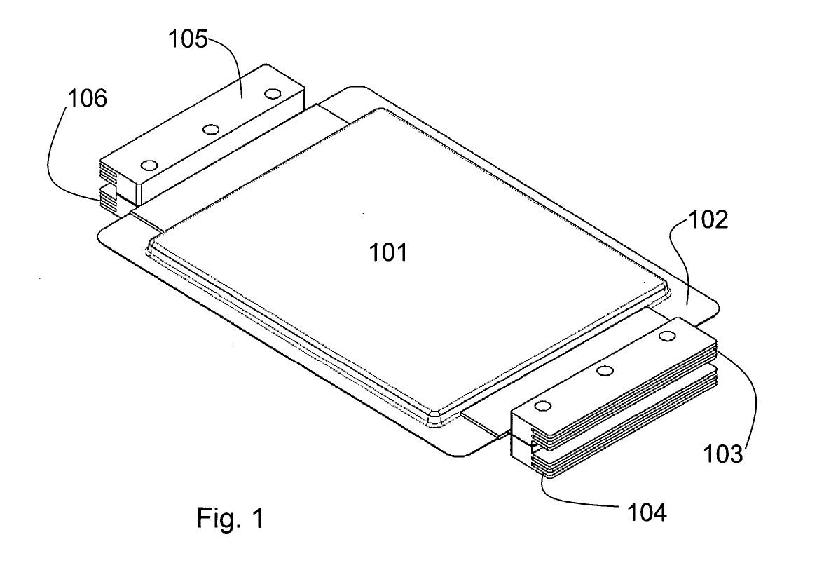

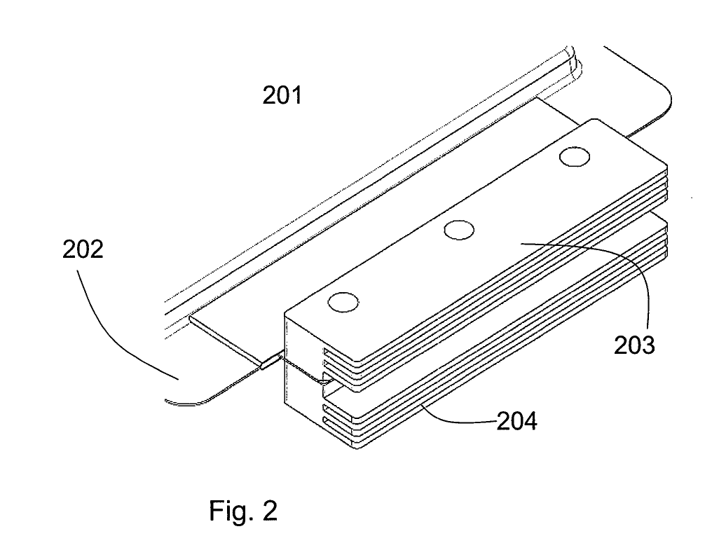

FIG. 1 is a galvanic cell according to the invention in accordance with a first embodiment of the invention, comprising cooling elements on both conductors of the cell;

FIG. 2 is an enlarged view of a detail of FIG. 1, including the cooling element disposed on the conductor;

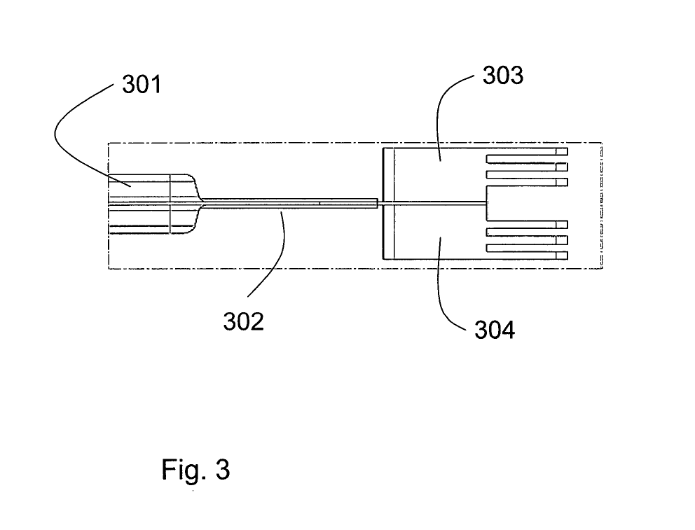

FIG. 3 is a sectional view of the detail shown in FIG. 2;

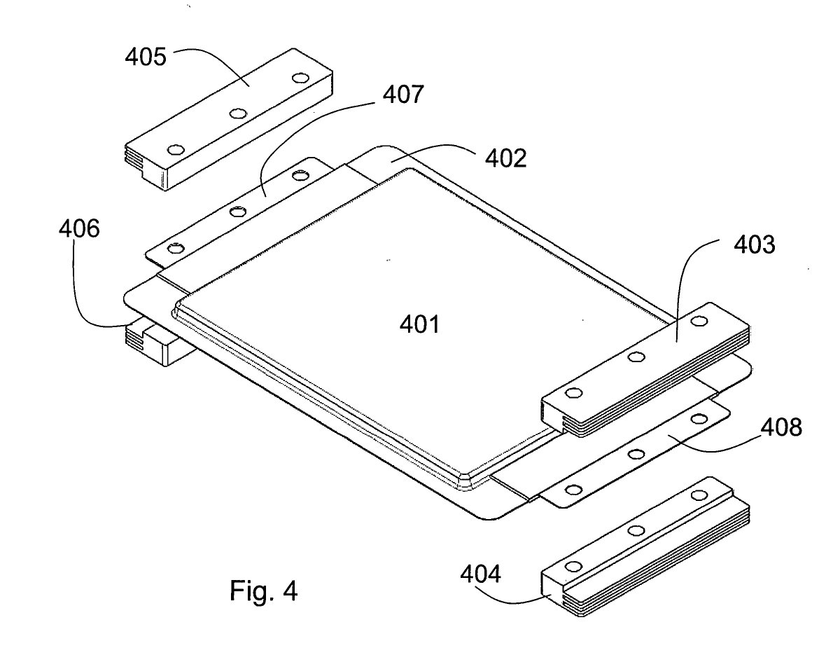

FIG. 4 is an exploded view of the exemplary embodiment of a galvanic cell according to the invention shown in FIG. 1;

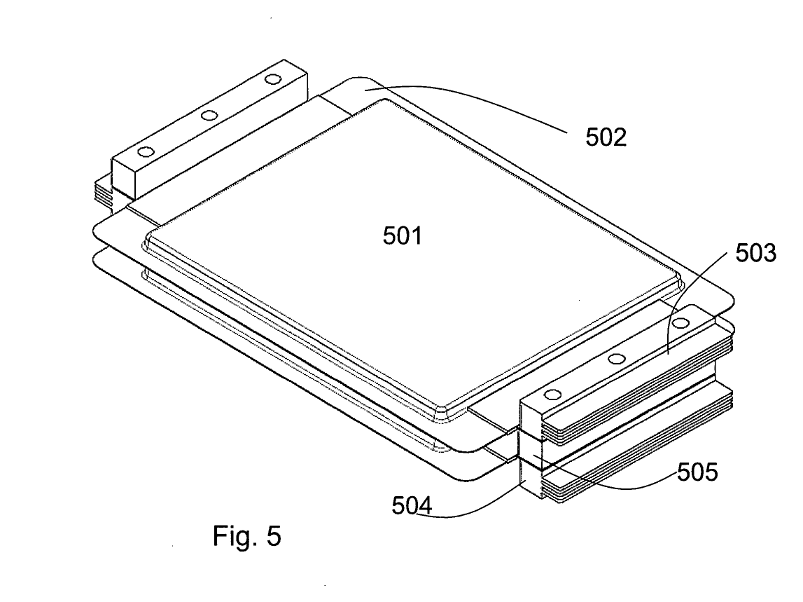

FIG. 5 is a cell stack composed of cells according to the invention in accordance with an exemplary embodiment of the invention;

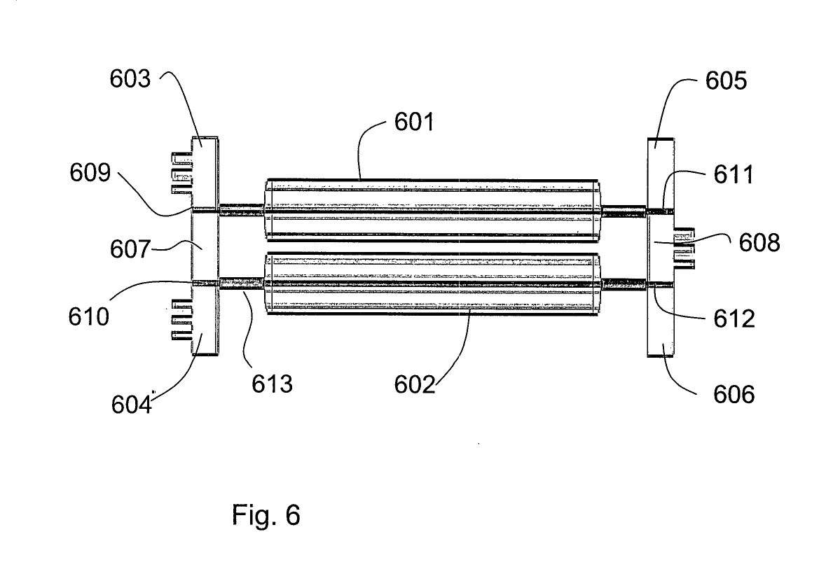

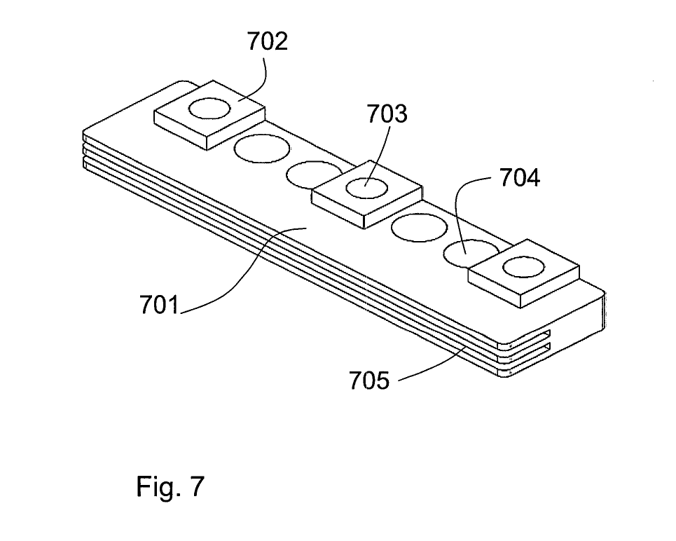

FIG. 6 is a sectional view of the cell stack shown in FIG. 5; and

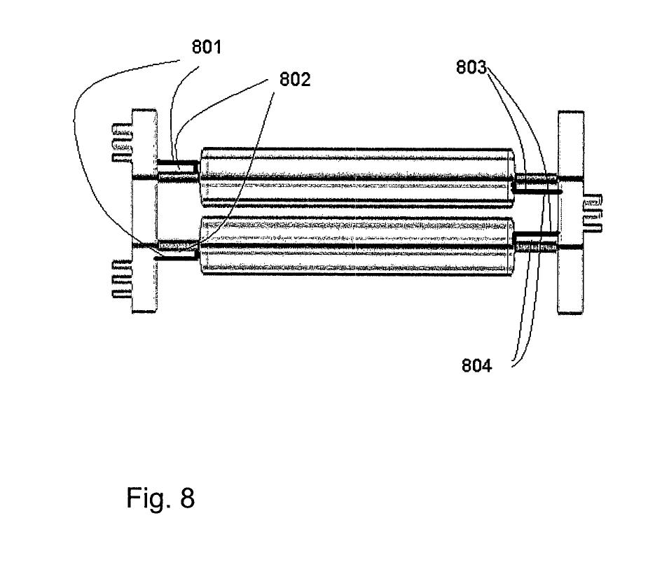

FIG. 7 is a cooling element in accordance with a preferred exemplary embodiment of the present invention.

Contrary to known forms of direct cooling of galvanic cells, in which lost heat that occurs during charging and discharging due to cooling fluid (air, water, cooling oil and the like) flowing around the cell housing is dissipated, according to the present invention the electric conductor of the galvanic cell is utilized for cooling the same. To this end, the present invention takes advantage of the observation that good electrical conductors are generally also good heat conductors.

The invention achieves this object by attaching cooling elements to the conductors. These cooling elements are disposed such that the conductors can also fulfill the original function thereof as electrical conductors and can additionally be used to transport heat out of the cell.

This can be done, for one, by producing the cooling elements at least partially or regionally from an electrically conductive material. If or to the extent this is desired, however, materials are available that combine comparatively high thermal conductivity with good electric insulating properties. Examples of such materials include ceramics that conduct heat well, but are electrically insulating. Materials such as silicon carbide and aluminum nitride, for example, are used as electric insulating materials for heat conducting purposes because of the relatively high thermal conductivity they have considering they are ceramic materials.

To this end, the cooling elements that are used can be produced, for example, from a metal, a ceramic material or—for example metal-ceramic—composites, as long as they have good heat conducting properties in the overall. They can be connected to the conductors positively, non-positively or by bonding, or in a combination of these joining methods.

Advantageously, the gap that frequently occurs between the conductor and the cooling element with a non-positive or positive application is bridged by thermally conductive potting compounds, adhesives, pastes or elastic thermally conductive films. So as to increase the heat transfer cross-section, the cooling elements can be provided with ribs, apertures or similar structures, which result in an increase in the surface.

Such ribs on the cooling element, or parts of such ribs, can be designed so that they are suited to conduct a cooling liquid, or to swirl it in a controlled manner, so as to improve the effective heat transfer. It is further advantageous for the cooling elements to also assume other functions. The cooling elements, for example, can also be used as electric contact elements, for example in order to enable an electric series connection of cells, or in order to allow an electric contact to be established with the current load or the current source.

Possible embodiments of the invention also include those in which the cooling elements are designed as retaining elements, which also fasten the cell or press the conductors against the contact elements. In any case, in terms of the electric conductivity, the cooling elements are preferably designed so that the main purpose thereof, which is to improve the cooling of the conductors, conforms to other aspects, such as the effective and intended contacting of the conductors.

FIGS. 1 to 4 shows an embodiment of the invention in which what is referred to as a pouch cell, which is to say a flat galvanic cell 101, 201, 301, 401, which is composed of a cell stack surrounded by a film-like packaging 102, 202, 302, 402, 502, 613 from which two conductors 407, 408 protrude, is provided with two cooling elements 103, 104, 105, 106, 203, 204, 303, 304, 403, 404, 405, 406 fastened to the upper and lower sides of the conductors, respectively.

FIGS. 5 and 6 show an embodiment of the invention in which the cooling elements 503, 504 are also used as contact elements for the electric series connection of cells in a cell block. For this purpose, the metallic cooling elements 603, 604, 608 are located between adjoining cells and connect the connectors thereof to one another. Retaining or insulating elements 505, 605, 606, 607 provide for the spacing of the cells on the side that is opposite of the electric connection. The insulating elements 505, 605, 606, 607, however, can also be designed as cooling elements.

FIG. 7 shows an embodiment of a cooling element 701 according to the invention comprising ribs in order to increase the effective surface thereof and additional holes or apertures 702, 703, 704 in the cooling element, which are also used to further increase the effective surface of the cooling element and reduce the weight thereof.

1. A galvanic cell (101, 201, 301, 401, 501, 601), comprising at least two connecting conductors (407, 408, 609, 610, 611, 612), in which at least one connecting conductor is provided with at least one cooling element (103, 104, 105, 106, 203, 204, 303, 304, 403, 404, 405, 406, 503, 504, 603, 604, 605, 606, 701), which is designed to allow the connecting conductor to be used for transporting electric energy into the cell or out of the cell and also to remove heat from the cell,
wherein
the at least one cooling element is designed at least partially or regionally as a contact element, insulating element and/or retaining element and configured to improve the cooling of the connecting conductors and contribute to an intended electric contacting of the connecting conductors.

2. The galvanic cell according to claim 1, wherein at least one connecting conductor is non-positively connected to at least one cooling element.

3. A galvanic cell according to claim 2, wherein at least one connecting conductor is positively connected to at least one cooling element.

4. A galvanic cell according to claim 3, wherein at least one connecting conductor is bonded to at least one cooling element.

5. A cooling element (701) for cooling galvanic cells, which is designed such that it can be attached non-positively or positively or bonded to a connecting conductor of a galvanic cell so that the connecting conductor can also be used to transport electric energy into the cell or out of the cell and to remove heat from the cell.

6. A stack composed of a plurality of galvanic cells (601, 602) according to claim 1.

7. The cell stack according to claim 6, comprising at least one galvanic cell that has at least one connecting conductor, which is equipped with at least one cooling element that can be used as a contact element.

8. The cell stack according to claim 6, comprising at least one galvanic cell that has at least one connecting conductor, which is equipped with at least one cooling element that can be used as an insulating element.

9. The cell stack according to claim 6, comprising at least one galvanic cell that has at least one connecting conductor, which is equipped with at least one cooling element that can be used as a retaining element.

10. (canceled)
